(19) United States
(12) Patent Application Publication
(10) Pub. No.: US 2024/0147585 A1
(43) Pub. Date: May 2, 2024

(54) GRAPHITE ELECTRODE, ELECTRIC FURNACE

(71) Applicant: TOKAI CARBON CO., LTD., Tokyo (JP)

(72) Inventors: Yohei Hirumi, Tokyo (JP); Yoshihiko Kashihara, Tokyo (JP); Mitsuhiro Adachi, Tokyo (JP)

(73) Assignee: TOKAI CARBON CO., LTD., Tokyo (JP)

(21) Appl. No.: 18/280,733

(22) PCT Filed: Sep. 29, 2021
(86) PCT No.: PCT/JP2021/035814

§ 371 Date: Sep. 7, 2023

(30) Foreign Application Priority Data
Mar. 16, 2021 (JP) 2021-042350

(51) Int. Cl. H05B 7/10; H05B 7/085

(52) U.S. Cl. CPC H05B 7/10; H05B 7/085

(57) ABSTRACT

A graphite electrode includes a pole having a socket in an internal screw shape at an end portion, and a nipple in an external screw shape that can be fastened to the socket, wherein a value obtained by subtracting an effective diameter on a small diameter end side of the nipple from an effective diameter on a small diameter end side of the socket is 0.05 to 0.7 mm, and a value obtained by subtracting a taper angle of the socket from a taper angle of the nipple is −2 minutes to −3 minutes 30 seconds.

### TECHNICAL FIELD

The present invention relates to a graphite electrode, and an electric furnace including the graphite electrode.

### BACKGROUND ART

In a graphite electrode of an electric furnace, a structure of an electrode connection portion in which breakage of a nipple is prevented is disclosed (for example, see Patent Literature 1). In this structure of the electrode connection portion, by providing a taper degree difference between the nipple and a socket, bias of stress that has been conventionally concentrated on a maximum diameter portion of the nipple is relaxed.

Similarly, in a graphite electrode of an electric furnace, a structure of a connection portion of the graphite electrode that prevents breakage of a nipple is disclosed (for example, see Patent Literature 2). In this structure of the connection portion, a spiral peripheral edge cut part having a cut width that gradually increases as it moves to a maximum diameter portion from a small diameter portion side is formed in the tapered nipple or a thread abutting side portion of an electrode socket. According to this, stress in the maximum diameter portion of the tapered nipple is relaxed, and breakage of the tapered nipple is prevented.

Further, in a graphite electrode of an electric furnace, a connection portion of the graphite electrode in which breakage of a nipple is prevented is disclosed (for example, see Patent Literature 3). The connection portion has a structure in which mountain portions of a plurality of threads are cut so as to gradually decrease from a small diameter portion side to a maximum diameter portion. According to this, stress concentration in the maximum diameter portion of the tapered nipple is relaxed, and breakage of the tapered nipple is prevented.

### CITATION LIST

### Patent Literature

[Patent Literature 1] Japanese Patent Publication No. 48-007735
[Patent Literature 2] Japanese Utility Model Publication No. 57-045676
[Patent Literature 3] Japanese Utility Model Publication No. 58-000958

### DISCLOSURE OF INVENTION

### Technical Problem

Defects of graphite electrodes include a defect that a part of a graphite electrode falls due to loosening of a screw between the nipple and the socket, in addition to breakage of a nipple due to stress concentration described above. Further, graphite electrodes are poor in processability because graphite electrodes are formed of graphite which is a hard brittle material, and there is a problem that when the socket and the nipple are formed into special shapes, as in Patent Literatures 2 and 3, a great deal of cost is required to accurately process the socket and the nipple into the shapes.

It is therefore an object of the present invention to provide a graphite electrode capable of reducing loosening of a screw between a nipple and a socket and also suppressing manufacturing cost.

### Solution to Problem

The above-described problem is solved by the present invention as follows. That is to say, a graphite electrode of the present invention (1) includes a pole including a socket in an internal screw shape at an end portion, and
a nipple in an external screw shape that can be fastened to the socket, wherein
a value obtained by subtracting an effective diameter on a small diameter end side of the nipple from an effective diameter on a small diameter end side of the socket is 0.05 to 0.7 mm, and
a value obtained by subtracting a taper angle of the socket from a taper angle of the nipple is −2 minutes to −3 minutes 30 seconds.

Further, a graphite electrode of the present invention (2) includes
a pole including a socket in an internal screw shape at an end portion, and
a nipple in an external screw shape that can be fastened to the socket, wherein
a value obtained by subtracting a linear expansion coefficient of the socket from a linear expansion coefficient of the pole is −0.4 to +0.5 (10^{-ε}/° C.).

Further, a graphite electrode of the present invention (3) is the graphite electrode according to (1) or (2), wherein
the nipple includes a first fastening portion that can be fastened to the socket, and a second fastening portion provided on an opposite side to the first fastening portion, and
loosening torque that is required to loosen a second pole fastened to the second fastening portion is at least 1.65 times greater than fastening torque that is required to fasten a second socket of the second pole to the second fastening portion of the nipple in a state where the first fastening portion is fastened to the socket.

Further, an electric furnace of the present invention (4) is an electric furnace including the graphite electrode according to any one of (1) to (3).

### Advantageous Effect of Invention

According to the present invention, it is possible to provide the graphite electrode in which loosening of the screw between the nipple and the socket is reduced.

### BRIEF DESCRIPTION OF DRAWINGS

FIG. 1 is a sectional view showing an electric furnace of an embodiment.

FIG. 2 is a sectional view showing an enlarged connection portion of a graphite electrode of the electric furnace shown in FIG. 1.

FIG. 3 is a sectional view showing an effective diameter d on a small diameter end side of the nipple of the graphite electrode shown in FIG. 2, and an effective diameter D on a small diameter end side of a socket of the graphite electrode.

FIG. 4 is a sectional view showing α/2 that is a half angle of a taper angle α of the nipple of the graphite electrode shown in FIG. 2, and β/2 that is a half angle of a taper angle β of the socket of the graphite electrode.

FIG. 5 is a graph showing CTE differences in a diameter direction of poles in examples B1 to B7 and comparative examples B1 to B7.

FIG. 6 is a graph showing relationships between effective diameter differences and taper angles, and loosening/fastening torque ratios of examples C1 to C4.

FIG. 7 is a graph showing relationships between effective diameter differences and taper angles, and loosening/fastening torque ratios of example C2, and comparative examples C1 to C3.

### DESCRIPTION OF EMBODIMENT

Hereinafter, an electric furnace will be described with reference to the drawings. The electric furnace can melt scrap of metal such as iron in a furnace by heat generated by discharge (arc) to produce molten steel.

### EMBODIMENT

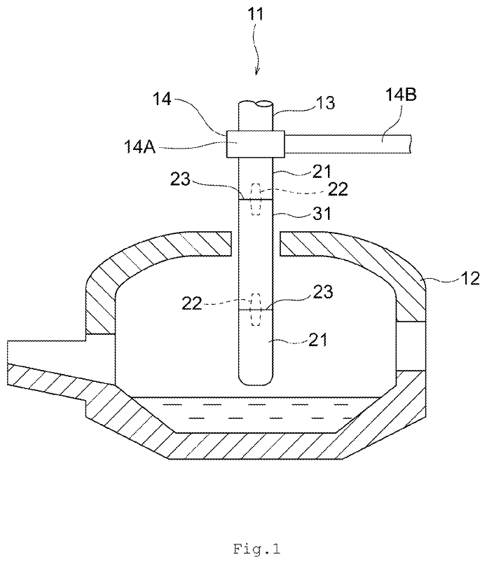

With reference to FIG. 1 to FIG. 4, an electric furnace 11 of an embodiment will be described. The electric furnace 11 includes a furnace body 12, a graphite electrode 13 that is suspended inside the furnace body 12, and a holder 14 that suspends the graphite electrode 13. The electric furnace 11 may be either an AC furnace or a DC furnace. When the electric furnace 11 is an AC furnace, the number of graphite electrodes 13 may be multiple.

The graphite electrode 13 can melt metal scrap charged into the furnace body 12 by high heat by discharging from a tip end toward a bottom part of the furnace body 12.

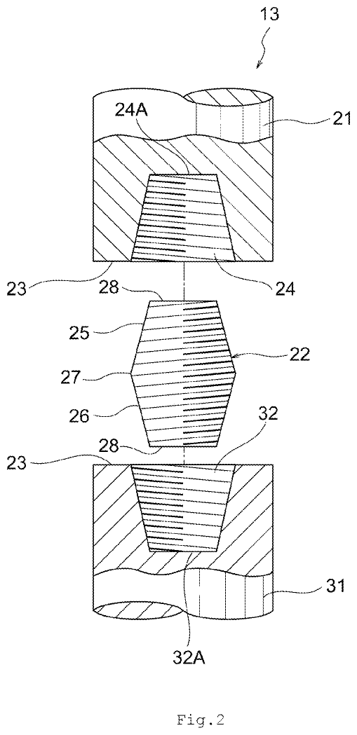

As shown in FIG. 1 and FIG. 2, the graphite electrode 13 has one or more cylindrical poles 21, and nipples 22 interposed as joints between the poles 21. Each of the pole 21 and the nipple 22 is formed of a solid composition containing a graphite as a main component.

Each of the poles 21 has a socket 24 recessed in a truncated cone shape at an end surface 23 thereof. An internal screw is formed on an inner peripheral surface of the socket 24. The nipple 22 can be received inside the socket 24.

The nipple 22 has a shape in which bottom surfaces of two cones each in a truncated cone shape are joined to each other. The nipple 22 has a first fastening portion 25 formed in a taper shape, a second fastening portion 26 provided on an opposite side to the first fastening portion 25 and formed in a taper shape, a maximum diameter portion 27 positioned in a boundary between the first fastening portion 25 and the second fastening portion 26, and a pair of small diameter ends 28 provided at respective tip ends of the first fastening portion 25 and the second fastening portion 26. A taper of the first fastening portion 25 and a taper of the second fastening portion 26 are formed in opposite directions. The respective taper of the first fastening portion 25 and taper of the second fastening portion 26 are formed so that diameter of the nipple 22 gradually decreases toward the small diameter ends 28 positioned at both ends from the maximum diameter portion 27 in a center. External screws are formed on outer peripheral surfaces of the first fastening portion 25 and the second fastening portion 26. The first fastening portion 25 of the nipple 22 can be fastened to the socket 24 of the pole 21. In a state where the first fastening portion 25 is fastened to the pole 21, a second pole 31 different from the pole 21 can be fastened to the second fastening portion 26 of the nipple 22. The second pole 31 has a second socket 32 on an end surface 23, and can be connected to the second fastening portion 26 via the second socket 32.

In the state where the pole 21 and the second pole 31 are fastened to the nipple 22 like this, predetermined gaps are formed respectively between the small diameter end 28 on a first fastening portion 25 side of the nipple 22 and a bottom portion 24A of the socket 24, and between the small diameter end 28 on a second fastening portion 26 side of the nipple 22 and a bottom portion 32A of the second socket 32.

The holder 14 has a ring-shaped holding tool 14A, and a support portion 14B capable of supporting the graphite electrode 13 via the holding tool 14A.

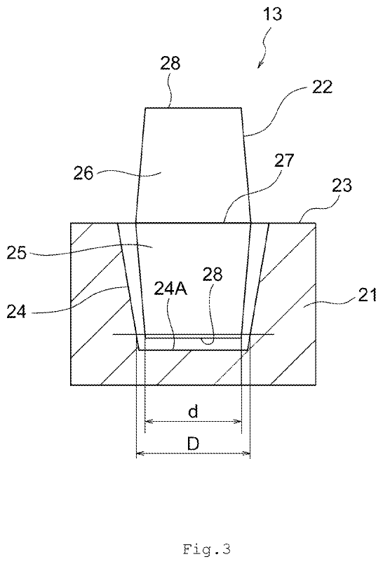

An “effective diameter of the nipple” means a diameter of a circle located in an intersection portion of a plane orthogonal to a nipple shaft in a position at a central portion of the nipple and a cone configuring a pitch line of a nipple screw thread, as defined in JIS R 7201. As shown in FIG. 3, an “effective diameter on a small diameter end side of the nipple” d of the present embodiment differs from this definition, and means a diameter of a circle located in an intersection portion of a plane orthogonal to a nipple axis in a position of the small diameter end 28, and a cone configuring the pitch line of the nipple screw thread.

An “effective diameter of a socket” means a diameter of a circle located in an intersection portion of a plane orthogonal to a socket axis, that is, a plane corresponding to a terminal end portion of the pole, and a cone configuring a pitch line of a socket screw thread as defined in JIS R 7201. Unlike this definition, as shown in FIG. 3, an “effective diameter on a small diameter end side of a socket” D of the present embodiment means a diameter of a circle located in an intersection portion of a plane of the nipple 22 orthogonal to a socket axis in a position of the small diameter end 28, and the cone configuring the pitch line of the socket screw thread. At this time, the maximum diameter portion 27 of the nipple 22 is in a boundary position between the pole 21 and the second pole 31 adjacent to the pole 21.

In the present embodiment, an effective diameter difference in the small diameter end 28, that is, a value obtained by subtracting an effective diameter on a small diameter end side of the nipple 22 from an effective diameter on a small diameter end side of the socket 24 is favorably 0.05 to 0.7 mm, preferably 0.06 to 0.5 mm, and more preferably 0.08 to 0.44 mm. If the effective diameter difference in the small diameter end 28 is less than 0.05 mm, torque that is required when fastening the nipple 22 and the second pole 31 to the pole 21 tends to be excessively large. If the effective diameter difference in the small diameter end 28 exceeds 0.70 mm, loosening torque that is required when detaching the nipple 22 and the second pole 31 from the pole 21 decreases, and the nipple 22 tends to be loosened with respect to the pole 21.

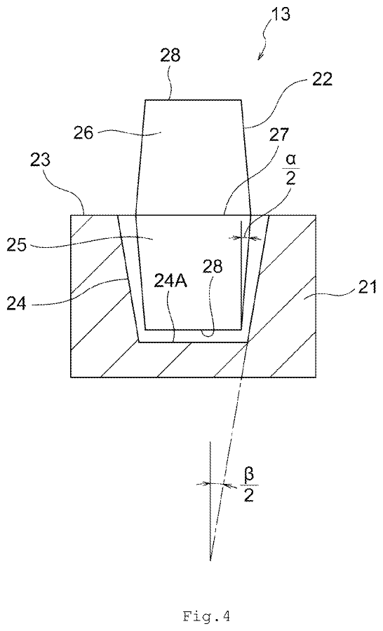

A taper angle refers to a total angle of a cone represented by a pitch line of a screw thread as defined in JIS R 7201. Accordingly, as shown in FIG. 4, a taper angle α of the nipple 22 corresponds to a value twice a gradient α/2 with respect to the nipple axis. A taper angle β of the socket 24 corresponds to a value twice a gradient β/2 with respect to the socket axis.

In the present embodiment, a taper angle difference between the nipple 22 and the socket 24, that is, a value obtained by subtracting the taper angle of the socket 24 from the taper angle of the nipple 22 is favorably −2 minutes to −4 minutes, preferably −2 minutes to −3 minutes 45 seconds, and more preferably −2 minutes to −3 minutes 30 seconds.

A linear expansion coefficient difference in a diameter direction of the pole 21 and the nipple 22 of the present embodiment, that is, a value obtained by subtracting a linear expansion coefficient of the socket 24 from a linear expansion coefficient of the pole 21 is preferably from −0.4 to +0.5 (10⁻⁶/° C.), and more preferably from −0.3 to +0.3 (10⁻⁶/° C.). When the linear expansion coefficient difference in the diameter direction of the pole 21 and the nipple 22 exceeds +0.5 (10⁻⁶/° C.), a possibility of causing cracking to the pole 21 is increased with thermal expansion of the pole 21 during use at high temperatures, and a possibility of also causing cracking to the nipple 22 by a fastening force of the pole 21 is increased. On the other hand, when the linear expansion coefficient difference in the diameter direction of the pole 21 and the nipple 22 is less than −0.4 (10⁻⁶/° C.), the nipple 22 is thermally expanded greatly with respect to the pole 21, a possibility of causing cracking to the nipple 22 is increased, and a possibility of also causing cracking to the pole 21 is increased by expansion pressure of the nipple 22.

The loosening/fastening torque ratio is a ratio of loosening torque that is maximum torque required to loosen the nipple in the state of being fastened to the socket with respect to fastening torque that is maximum torque required when fastening the nipple to the socket. The loosening/fastening torque ratio is favorably at least one or more, preferably at least 1.6 or more, and more preferably at least 1.65 or more.

A method for manufacturing the pole 21 and the nipple 22 will be described. Needle coke derived from petroleum and/or needle coke derived from coal are ground and mixed respectively, and are heated to a high temperature, and the heated needle coke is mixed with a binder pitch at a predetermined rate. When a thermal expansion coefficient of the needle coke that is used at this time is small, a linear expansion coefficient in the diameter direction of the pole 21 and the nipple 22 that is finally obtained becomes small. The binder pitch is obtained by distilling and thermally modifying coal tar obtained by dry distillation of coal. Paste that is cooled to a constant temperature is charged into an extrusion molding machine and is pressed at a constant speed. A molded body (raw electrode) is cooled after extruded for each size. When needle coke having good acicular properties is used, needle coke is more likely to be oriented to be parallel to an extrusion direction in the extrusion molding operation. When a raw electrode is manufactured by extrusion conditions having the high orientation, the linear expansion coefficient in the diameter direction of the pole 21 and the nipple 22 that are finally obtained is increased.

Subsequently, in a primary firing step, the binder pitch in the molded body is carbonized. The raw electrode is placed in a firing furnace, and is fired to approximately 1000° C. This forms a carbon skeleton (fired electrode) of the electrode.

Subsequently, a pitch infiltration step is performed, and the fired electrode is impregnated with a pitch derived from coal tar in an impregnation tank. This achieves densification of the fired electrodes. By the densification, strength, electric resistance characteristics and the like of the electrode are improved.

Subsequently, a secondary firing step of the fired electrode is performed again in the firing furnace, the temperature is increased to approximately 700° C., and the impregnated pitch is carbonized.

Further, in a graphitization step, in an LWG furnace or an Acheson furnace, the fired electrode is heated to an ultra-high temperature of about 2000 to 3000° C. and heat-treated. This crystallizes carbon structure into graphite. This forms a graphite electrode material. The higher the temperature of this heating treatment, the larger the linear expansion coefficient in the diameter direction of the pole 21 and the nipple 22 that are finally obtained.

The pole 21 and the nipple 22 are produced by processing the electrode material. In the processing step, profile processing and threading processing are performed according to dimensional standards by a dedicated processing machine.

The processed products (the pole 21, the nipple 22) undergo visual inspection, screw precision inspection and the like. Further, by a 100% automatic inspection machine, a length, weight, and various characteristic values of each electrode are measured. The electrodes for which inspection is finished are packed and shipped.

In shipping, one nipple 22 may be fastened in advance to the socket 24 that is provided on one end surface of the pole 21, and thus the pole 21 and the nipple 22 may be shipped as a product in an integrated state.

### EXAMPLES

### (Example A) Evaluation Concerning the Effective Diameter Difference and the Taper Angle Difference in the Small Diameter End

With respect to the graphite electrode (product of respective dimensional standards) manufactured by the manufacturing method described above, the graphite electrodes were each manufactured by setting the effective diameter d on the small diameter end side of the nipple, the effective diameter D on the small diameter end side of the socket, the effective diameter difference in the small diameter end, the nipple side taper angle, the socket side taper angle, and the taper angle difference as in Table 1 and Table 2 described below. Respective numeric values of the effective diameter d on the small diameter end side of the nipple, the effective diameter D on the small diameter end side of the socket, the nipple side taper angle, and the socket side taper angle are actual measured values measured by using a gauge. Further, a point at which a maximum value or a minimum value of the effective diameter d on the small diameter end side of the nipple is taken, and a point at which a maximum value or a minimum value of the effective diameter D on the small diameter end side of the socket is taken do not usually match with each other. Therefore, a value obtained by subtracting the maximum value of the effective diameter d on the small diameter end side of the nipple from the maximum value of the effective diameter D on the small diameter end side of the socket is not a maximum value of the effective diameter difference in the small diameter end.

Explaining the dimensional standards by taking comparative example A1 (24×110−24T4W) as an example, with the hyphen in-between, the numbers on the left side indicate the dimensions of the pole, and indicate 24 inches in diameter by 110 inches in length. With the hyphen in-between, number 24 on the right side indicates the size of the nipple, and indicates the nipple of the type corresponding to the pole of 24 inches in diameter, and the letters indicate a predetermined model number.

Example A1 is improved in effective diameter difference and taper angle difference with respect to comparative example A1, similarly hereinafter, examples A2 and A2′ are improved in effective diameter difference and taper angle difference with respect to comparative example A2, examples A3 and A3′ are improved in effective diameter difference and taper angle difference with respect to comparative example A3, examples A4 and A4′ are improved in effective diameter difference and taper angle difference with respect to comparative example A4, and example A5 is improved in effective diameter difference and taper angle difference with respect to comparative example A5.

In each of comparative examples and examples in which the poles are connected to each other via the nipple, the case in which loosening, falling-off, breakage, rattling or the like occurs to the connection portion was determined as a “defect”, and the ratio of the number of “defects” to the total number of measurements was calculated as a “defect rate”. The results are shown in Table 2.

TABLE 1

| | | nipple side | | socket side | | effective | |
|---|---|---|---|---|---|---|---|
| | | effective | | effective | | diameter | |
| | | diameter d | | diameter D | | difference D-d | |
| | dimensional | (mm) | | (mm) | | (mm) | |
| | standards | min. | max. | min. | max. | min. | max. |
| comparative | 24 × 110-24T4W | 314.12 | 314.20 | 314.49 | 314.60 | 0.25 | 0.41 |
| example A1 | | | | | | | |
| example A1 | 24 × 110-24T4W | 314.01 | 314.12 | 314.52 | 314.57 | 0.27 | 0.43 |
| comparative | 28 × 110-28T4L | 371.22 | 371.29 | 371.67 | 371.70 | 0.30 | 0.36 |
| example A2 | | | | | | | |
| example A2 | 28 × 110-28T4L | 371.27 | 371.31 | 371.66 | 371.72 | 0.13 | 0.24 |
| example A2′ | 28 × 110-28T4L | 371.15 | 371.22 | 371.61 | 371.77 | 0.19 | 0.44 |
| comparative | 30 × 110-30T4L | 403.10 | 403.18 | 403.38 | 403.50 | 0.14 | 0.30 |
| example A3 | | | | | | | |
| example A3 | 30 × 110-30T4L | 403.01 | 403.10 | 403.39 | 403.49 | 0.08 | 0.21 |
| example A3′ | 30 × 110-30T4L | 402.87 | 402.97 | 403.41 | 403.46 | 0.24 | 0.33 |
| comparative | 20 × 096-18T3L | 268.60 | 268.69 | 269.01 | 269.13 | 0.29 | 0.42 |
| example A4 | | | | | | | |
| example A4 | 20 × 096-18T3L | 268.57 | 268.65 | 269.05 | 269.12 | 0.19 | 0.38 |
| example A4′ | 20 × 096-18T3L | 268.54 | 268.61 | 269.03 | 269.11 | 0.25 | 0.39 |
| comparative | 30 × 110-30T4L | 402.94 | 403.10 | 403.39 | 403.46 | 0.26 | 0.41 |
| example A5 | | | | | | | |
| example A5 | 30 × 110-30T4L | 403.01 | 403.09 | 403.41 | 403.46 | 0.11 | 0.21 |

TABLE 2

| | | | | | | | | defect |
|---|---|---|---|---|---|---|---|---|
| | nipple side taper | | socket side taper | | taper angle | | defect | reduction |
| | angle (′) | | angle (′) | | difference (′) | | rate | rate |
| | min. | max. | min. | max. | min. | max. | (%) | (%) |
| comparative | 18°55′03″ | 18°56′11″ | 18°56′00″ | 18°56′26″ | −0′15″ | −1′20″ | 3.3 | 72.7 |
| example A1 | | | | | | | | |
| example A1 | 18°54′00″ | 18°55′03″ | 18°55′44″ | 18°56′26″ | −0′47″ | −2′26″ | 0.9 | |
| comparative | 18°54′31″ | 18°54′52″ | 18°56′00″ | 18°56′32″ | −1′05″ | −1′50″ | 2.4 | 100 |
| example A2 | | | | | | | | |
| example A2 | 18°52′47″ | 18°53′44″ | 18°55′55″ | 18°56′21″ | −02′10″ | −3′20″ | 0 | |
| example A2′ | 18°53′13″ | 18°54′05″ | 18°55′44″ | 18°56′32″ | −1′35″ | −2′55″ | 0 | |
| comparative | 18°54′47″ | 18°55′50″ | 18°55′39″ | 18°56′47″ | +0′05″ | −1′55″ | 0.9 | 100 |
| example A3 | | | | | | | | |
| example A3 | 18°52′52″ | 18°53′29″ | 18°55′39″ | 18°56′26″ | −2′20″ | −3′20″ | 0 | |
| example A3′ | 18°52′47″ | 18°53′49″ | 18°56′05″ | 18°56′26″ | −2′30″ | −3′30″ | 0 | |
| comparative | 18°54′35″ | 18°55′18″ | 18°56′05″ | 18°56′26″ | −0′45″ | −1′35″ | 0.9 | 100 |
| example A4 | | | | | | | | |
| example A4 | 18°52′52″ | 18°54′13″ | 18°56′00″ | 18°56′21″ | −1′50″ | −3′10″ | 0 | |
| example A4′ | 18°53′03″ | 18°53′30″ | 18°55′55″ | 18°56′26″ | −2′25″ | −3′10″ | 0 | |
| comparative | 18°54′47″ | 18°55′44″ | 18°56′05″ | 18°56′37″ | −0′35″ | −1′20″ | 6.7 | 100 |
| example A5 | | | | | | | | |
| example A5 | 18°52′47″ | 18°53′39″ | 18°55′55″ | 18°56′11″ | −2′20″ | −3′10″ | 0 | |

When comparative example A1 was improved so as to have the effective diameter difference and the taper angle difference as in example A1, the defect rate decreased to 0.9% from 3.3%, and a defect reduction rate was 72.7%. When comparative example A2 was improved to have the effective diameter difference and the taper angle difference as in example A2 or example A2′, the defect rate decreased to 0% from 2.4%, and the defect reduction rate was 100%. When comparative example A3 was improved to have the effective diameter difference and the taper angle difference as in example A3 or example A3′, the defect rate decreased to 0% from 0.9%, and the defect reduction rate was 100%. When comparative example A4 was improved to have the effective diameter difference and the taper angle difference as in example A4 or example A4, the defect rate decreased to 0% from 0.9%, and the defect reduction rate was 100%. When comparative example A5 was improved to have the effective diameter difference and the taper angle difference as in example A5, the defect rate decreased to 0% from 6.7%, and the defect reduction rate was 100%.

### (Example B) Evaluation Concerning the Difference Between the Linear Expansion Coefficient of the Pole and the Linear Expansion Coefficient of the Nipple

A diameter direction CTE (Coefficient of Thermal Expansion) difference, that is, a value obtained by subtracting a linear expansion coefficient of the nipple with respect to the diameter direction of the nipple from a linear expansion coefficient of the pole with respect to the diameter direction of the pole was set as follows. Note that it is known that the linear expansion coefficients of the pole and the nipple have a positive correlation with volume resistivities thereof. It is possible to measure the linear expansion coefficients of the pole and the nipple, by obtaining the linear expansion coefficient corresponding to the linear expansion coefficient in advance to create an experimental calibration line, and measuring the volume resistivities.

In other words, the diameter direction CTE differences of comparative examples B1 to B7 were all large regardless of positive or negative, and specifically, absolute values thereof exceeded 0.5. Here, the diameter of the pole of comparative example B1 is 32 inches, the diameter of the pole of comparative example B2 is 30 inches, the diameter of the pole of comparative example B3 is 28 inches, the diameters of the poles of comparative examples B4 to B6 are 24 inches, and the diameter of the pole of comparative example B7 is 20 inches.

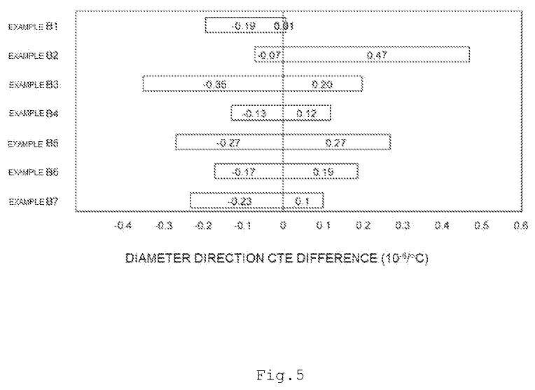

The diameter direction CTE differences of comparative examples B1 to B7 were changed as shown in FIG. 5, by properly changing the manufacturing conditions of the pole and the nipple (the thermal expansion coefficient of the needle coke, acicular properties, and the heat treatment temperature of the graphitization treatment). In other words, the diameter direction CTE difference in example B1 was −0.19 to 0.01 (10⁻⁶/° C.), the diameter direction CTE difference in example B2 was −0.07 to 0.47 (10⁻⁶/° C.), and the diameter direction CTE difference of example B3 was −0.13 to 0.12 (10⁻⁶/° C.). Further, the diameter direction CTE difference of example B4 was −0.27 to 0.27 (10⁻⁶/° C.), the diameter direction CTE difference of example B5 was −0.27 to 0.27 (10⁻⁶/° C.), the diameter direction CTE difference of example B6 was −0.17 to 0.19 (10⁻⁶/° C.), and the diameter direction CTE difference of example B7 was −0.23 to 0.1 (10⁻⁶/° C.). Here, the diameter of the pole of example B1 is 32 inches, the diameter of the pole of example B2 is 30 inches, the diameter of the pole of example B3 is 28 inches, the diameters of the poles of examples B4 to B6 are 24 inches, and the diameter of the pole of example B7 is 20 inches.

As a result, the number of occurrences of defects such as loosening, falling-off, breakage and rattling in the connection portion became zero, and the defect reduction rate was 100%.

### (Example C) Evaluation Concerning the Effective Diameter Difference and Taper Angle Difference, and the Loosening/Fastening Torque Ratio

Relationship between the effective diameter difference and taper angle difference, and the loosening/fastening torque ratio of the pole and the nipple of the dimensional standards 24×110−24T4W was evaluated. The electrode connecting machine made by CIS was used in fastening work of the nipple to the pole, the loosening work that loosens the nipple from the pole, and the measuring work of the loosening/fastening torque ratio.

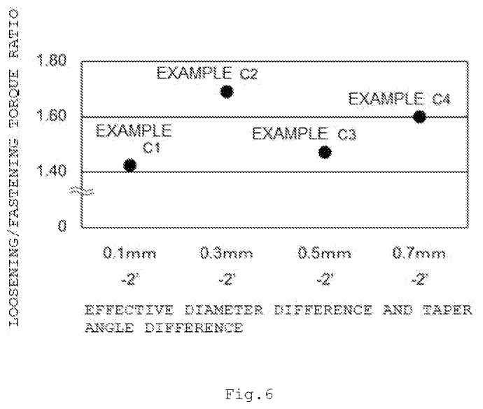

The taper angle differences of examples C1 to C4 were indiscriminately set at −2 minutes, and the influences of the effective diameter differences (effective diameter differences in the small diameter ends) were evaluated. The effective diameter differences (effective diameter differences in the small diameter ends) of examples C1 to C4 were respectively 0.1 mm, 0.3 mm, 0.5 mm, and 0.7 mm. The number of evaluations for each of examples C1 to C4 was 3 (N=3), and an average value thereof was adopted as the result of the loosening/fastening torque ratio. The evaluation results are shown in FIG. 6. The loosening/fastening torque ratios of examples C1 to C4 were respectively 1.42, 1.68, 1.47, and 1.59. Accordingly, it is understood that as for the effective diameter difference, 0.3 mm and a value in the vicinity thereof are the most desirable in the viewpoint of being able to prevent the nipple from being loosened from the socket of the pole.

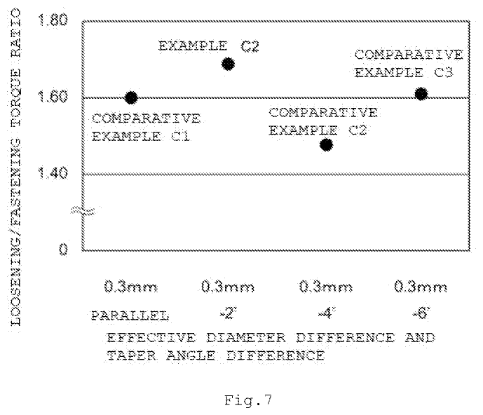

Next, the effective diameter differences of example C2 and comparative examples C1 to C3 were indiscriminately set at 3 mm, and influences of the taper angle differences were evaluated. The taper angle difference of example C2 was −2 minutes, and the taper angle differences of comparative examples C1 to C3 were parallel (taper angle difference of 0), −4 minutes, and −6 minutes respectively. The number of evaluations of each of example C2, and comparative examples C1 to C3 was 3 (N=3), and an average value thereof was adopted as the result of the loosening/fastening torque ratio. The evaluation results are shown in FIG. 7. The loosening/fastening torque ratio of example C2 was 1.68, and the loosening/fastening torque ratios of comparative examples C1 to C3 were respectively 1.59, 1.50, and 1.62. Accordingly, it is understood that the taper angle difference is most desirably −2 minutes of example C2 and a value in the vicinity thereof from a viewpoint of being able to prevent the nipple from being loosened from the socket of the pole. On the other hand, it is understood that when the taper angle difference is parallel (taper angle difference of 0), or −4 minutes or less, a variation occurs to the loosening/fastening torque ratio, and the value of the loosening/fastening torque ratio does not become a stable high value.

According to the above-described embodiment and the above-described examples, the following can be said. The graphite electrode 13 includes the pole 21 having the socket 24 in an internal screw shape at the end portion, and the nipple 22 in an external screw shape that can be fastened to the socket 24, the value obtained by subtracting the effective diameter on the small diameter end 28 side of the nipple 22 from the effective diameter on the small diameter end 28 side of the socket 24 is 0.05 to 0.70 mm, and the value obtained by subtracting the taper angle of the socket 24 from the taper angle of the nipple 22 is −2 minutes to −3 minutes 30 seconds.

According to this configuration, it is possible to increase the loosening/fastening torque ratio, and it is possible to realize the graphite electrode in which the nipple 22 is less likely to be loosened with respect to the pole 21. Accordingly, it is possible to decrease the defect rate. Further, special processing such as cutting to the screw portion is not particularly required, and it is possible to prevent the manufacturing cost of the graphite electrode from being extremely increased.

The graphite electrode 13 includes the pole 21 having the socket 24 in the internal screw shape at the end portion, and the nipple 22 in the external screw shape that can be fastened to the socket 24, and the value obtained by subtracting the linear expansion coefficient of the nipple 22 from the linear expansion coefficient of the pole 21 is −0.4 to +0.5 (10⁻⁶/° C.). According to the configuration, it is possible to realize the graphite electrode 13 in which the nipple 22 is less likely to be loosened with respect to the pole 21 and reduce a probability of causing a defect such as loosening.

In these cases, the loosening torque that is required to loosen the nipple 22 fastened to the socket 24 is at least 1.65 times greater than the fastening torque that is required to fasten the nipple 22 to the socket 24. According to the configuration, it is possible to realize the graphite electrode 13 in which the nipple 22 is easily fastened to the pole 21, the nipple 22 is less likely to be loosened with respect to the pole 21, and thereby a defect is less likely to occur, by increasing a so-called loosening/fastening torque ratio.

The electric furnace 11 includes the graphite electrode 13 described above. According to this configuration, it is possible to realize the electric furnace 11 with high reliability which is less likely to cause a defect such as loosening in the connection portion in the graphite electrode 13.

### REFERENCE SIGNS LIST

11 electric furnace
12 furnace body
13 graphite electrode
14 holder
14A holding tool
14B support portion
21 pole
22 nipple
23 end surface
24 socket
24A bottom portion
25 first fastening portion
26 second fastening portion
27 maximum diameter portion
28 small diameter end
31 second pole
32 second socket
32A bottom portion

1. A graphite electrode comprising:
a pole including a socket in an internal screw shape at an end portion; and
a nipple in an external screw shape that can be fastened to the socket, wherein
a value obtained by subtracting an effective diameter on a small diameter end side of the nipple from an effective diameter on a small diameter end side of the socket is 0.05 to 0.7 mm, and
a value obtained by subtracting a taper angle of the socket from a taper angle of the nipple is −2 minutes to −3 minutes 30 seconds.

2. A graphite electrode comprising:
a pole including a socket in an internal screw shape at an end portion; and
a nipple in an external screw shape that can be fastened to the socket, wherein
a value obtained by subtracting a linear expansion coefficient of the nipple from a linear expansion coefficient of the pole is −0.4 to +0.5 (10⁻⁶/° C.).

3. The graphite electrode according to claim 1, wherein loosening torque that is required to loosen the nipple fastened to the socket is at least 1.65 times greater than fastening torque that is required to fasten the nipple to the socket.

4. An electric furnace comprising the graphite electrode according to claim 1.

5. The graphite electrode according to claim 2, wherein loosening torque that is required to loosen the nipple fastened to the socket is at least 1.65 times greater than fastening torque that is required to fasten the nipple to the socket.
